(19) United States
(12) Patent Application Publication
(10) Pub. No.: US 2010/0179905 A1
(43) Pub. Date: Jul. 15, 2010

(54) Web-Based Coordination of Volunteer Sign-Up Sheets

(75) Inventors: Nazila Alasti, Stanford, CA (US); Deborah May Shepard, Portola Valley, CA (US)

Correspondence Address: FENWICK & WEST LLP, SILICON VALLEY CENTER, 801 CALIFORNIA STREET, MOUNTAIN VIEW, CA, 94041, US

(73) Assignee: HOMAJOON

(21) Appl. No.: 12/617,553

(22) Filed: Nov. 12, 2009

Related U.S. Application Data
(60) Provisional application No. 61/199,724, filed on Nov. 18, 2008.

(51) Int. Cl. G06Q 50/00; G06Q 20/00; G06Q 10/00; G06F 3/14

(52) U.S. Cl. 705/39; 705/301; 715/234

(57) ABSTRACT

A light-weight, easy to use, commonly accessible, sign-up sheet that can be sent to volunteers and/or participants on email or social media vehicles. The sign-up sheet preferably has some or all of the following features. In some cases, the sign-up sheet auto-updates and keeps everyone informed. It preferably aids the organizer (and volunteers) in dealing with changes to the sign-up sheet. In one aspect, organizers can pre-assign volunteers to tasks. The sign-up sheet, preferably at all times, helps all parties involved to keep an accurate and current record of commitments to tasks, including commitments of time, items and payments, without the need to resort to multiple unnecessary broadcast emails. The platform preferably allows the organizer to send automated reminder emails to volunteers at the right time with the correct information.

### CROSS-REFERENCE TO RELATED APPLICATION(S)

This application claims priority under 35 U.S.C. §119(e) to U.S. Provisional Patent Application Ser. No. 61/199,724, “Web-based Coordination and Payments,” filed Nov. 18, 2008. The subject matter of all of the foregoing is incorporated herein by reference in their entirety.

### BACKGROUND OF THE INVENTION

1. Field of the Invention

This invention relates generally to the coordination of volunteers using web-based sign-up sheets.

2. Description of the Related Art

Coordinating a group for an activity can be a complicated task with many moving parts. The organizer of the activity may have to coordinate many people who are volunteering for a large number of specific tasks. The tasks may take place at different times, in shifts, at different locations. Some tasks may require specialized skill. The organizer may also have to coordinate people who are bringing items to the activity. As part of this coordination, the organizer may want to pre-assign certain volunteers to certain tasks. The organizer typically will also want to exert some control over volunteers changing their commitments. Many activities also involve some sort of payment, which adds an additional dimension of tracking and handling money.

This coordination task can be even more difficult for informal, intermittent or transient groups of moderate to large size. Such groups may exist for only one activity or a small number of activities. Since they are transient, it does not make sense to use a complicated, powerful coordination tool. By the time the volunteers learn how to use such a tool, the group's usefulness will be over, which means that the tool will not be used during the useful life of the group. On the other hand, since the group is moderate or large, simple approaches such as sending emails to everyone can be inefficient at best and completely bothersome and ineffective at worst.

Furthermore, there are a large number of activities and groups that fall into this category. For example, the “social director” of a company department may be organizing a potluck dinner for the department, and must coordinate who is bringing what in addition to who is coming. Or a PTA committee chair may be organizing a carnival fundraiser for a local school, and must coordinate who is manning which carnival booths as well as who is bringing supplies, setting up and cleaning up. Or a community volunteer may be organizing a local food drive, and must coordinate who will cover which neighborhoods at which times. Or a soccer coach may be organizing practices and games, and must coordinate who will bring snacks, sports equipment and serve as referees, set up and clean up.

Organizers of these activities typically would like to perform several tasks. It is often beneficial to create and manage a common auto-updating web page for volunteers for an activity. Organizers often desire to intelligently manage sign-ups with the changes that occur around the activity and to communicate them effectively to impacted volunteers. In some cases, organizers desire to pre-assign volunteers if needed and keep track of them as if they had signed up on their own (e.g., provide updates, reminders and thank you notes).

In addition, from the volunteer's perspective, the ability to volunteer and commit to certain tasks in an activity should be simple and straightforward. Volunteers may also desire to contribute in a coordinated way to the activity and to participate in the online coordination effort for the activity. If payments are required, it would be beneficial to enable volunteers to make corresponding payments (e.g., for dues and donations) at the same time and on the same web site as they sign-up for the activity. To simplify sign-ups, volunteers preferably should be able to commit to tasks without having to first register for a service or otherwise provide significant additional information.

Existing web-based sites and products generally are not satisfactory for this type of coordination. Some current products provide one way announcement of events with RSVPs from invitees (Evite). However, these products typically do not provide enough power or flexibility to allow the organizer to effectively coordinate the group effort.

Other group solutions, such as Y!Groups and emails work well only when communicating one way (i.e., broadcasting information from group moderator/leader to participants). However, because of the back-and-forth nature of group coordination, these same products fail to accommodate user needs both for the organizer as well as the participants of sign-up sheets. The larger the group, the more cumbersome and unwieldy the one-way products become. Multiple sets of emails, questions and confirmations are often necessary, with the communications often broadcast to an overly large group. For example, in a group size of 20 (average elementary school classroom size) when using Y!Groups, for every one useful Y!Group message, each member typically receives many non-useful messages as part of the coordination effort.

As a result of these inherent limitations, it can be difficult to keep track of who has committed to do which tasks and who to contact if there is a change in tasks or schedule. It can even be difficult for volunteer candidates to determine which tasks are committed and which are available. Furthermore, if there is a payment element involved, the organizer often goes through the additional trouble of setting up a separate account on a separate site for the payment to be made and participants are asked to sign-up for activities on one product and then do the payments on yet a different product. As a result, many payments are currently done in cash or checks and therefore add another layer of cumbersomeness.

Thus, there is a need for approaches that better facilitate the coordination of medium-to-large groups of volunteers and/or complex projects with multiple layers of volunteers involved.

### SUMMARY OF THE INVENTION

In one aspect, the present invention overcomes the limitations of the prior art by allowing organizers to create a light-weight, easy to use, commonly accessible, sign-up sheet that can be sent to volunteers and/or participants on email or other social media vehicles. The sign-up sheet preferably has some or all of the following features. In some cases, the sign-up sheet auto-updates and keeps everyone informed. It preferably aids the organizer (and volunteers) in dealing with changes to the sign-up sheet. In one aspect, organizers can pre-assign volunteers to tasks. The sign-up sheet preferably helps all parties involved to keep an accurate and current record of commitments to tasks, including commitments of time, items and payments, without the need to resort to multiple unnecessary broadcast emails. The platform preferably allows the organizer to send automated reminder emails to volunteers at the right time with the correct information. Preferably, it also allows for customized thank you notes.

In one approach according to the invention, a software platform enables group sign-up sheets on the Internet. As example, a sign-up sheet could be for organizing snack duty for a soccer team (different families bring snacks on different weeks), or organizing carpools (to drive to and from different locations on different days and different times) or creating a teacher's wish list for parents to donate money or purchase items from the list.

In one design, easy-to-use templates and widgets allow a user in a limited number of simple steps to create a sign-up sheet and email a URL for the sign-up sheet to volunteer candidates. The volunteer candidates receive the emails in their usual email box. By clicking on the URL, they are able to see which tasks on the sign-up sheet are available and which are taken (i.e., already committed). The information reflects the current status of the sign-up sheet, avoiding problems such as double-booking and accommodating modifications by the organizer (change management). In cases where changes are made to the sign-up sheet, communications are sent to the impacted volunteers, without bothering the non-impacted volunteers. Automatic reminders and calendar Task Notes can also be generated by the platform. In addition, the platform can provide pre-filled templates for specific occasions that an organizer could use as the starting point of building their sign-up sheets.

Many times during the sign-up process, volunteers are also asked to make payments or donate money, for example towards the purchase of a gift, to pay for uniforms or buy tickets for the event where they are volunteering. In one aspect of the invention, the software platform includes a group coordination product with payment capabilities enabling users to coordinate online while also making the necessary payments.

Other aspects of the invention include methods corresponding to the devices and systems described above.

### BRIEF DESCRIPTION OF THE DRAWINGS

The invention has other advantages and features which will be more readily apparent from the following detailed description of the invention and the appended claims, when taken in conjunction with the accompanying drawings, in which:

FIG. 1 is a screenshot that shows a home page for a service according to the invention.

FIG. 2A is a screenshot that shows a first step in creating a sign-up sheet.

FIG. 2B is a screenshot that shows a completed sign-up sheet.

FIG. 2C is a screenshot that shows a gallery of sign-up sheets.

FIG. 2D is a screenshot that shows a sign-up sheet selected from the gallery.

FIG. 3A is a screenshot that shows the ability to edit a sign-up sheet.

FIG. 3B is a screenshot of a dialog box for editing volunteers.

FIG. 4 is a screenshot that shows an ability to assign payments to the sign-up sheet.

FIG. 5 is a screenshot that shows Amazon' s interface to Jooners.

FIG. 6 is a screenshot that shows completing the sign-up sheet creation process.

FIG. 7A is a screenshot that shows an email generated and sent from Jooners.

FIG. 7B is a screenshot that shows an email containing the URL of the sign-up sheet.

FIG. 8 is a screenshot of the sign-up sheet displayed to the volunteer candidate.

FIG. 9 is a screenshot that shows a payments page.

FIG. 10 is a screenshot that shows confirmation of successful sign-up and payment to the volunteer.

FIG. 11 is a screenshot that shows the results of modification to an existing sign-up sheet.

FIG. 12 is a screenshot that shows reminders.

FIG. 13A is a screenshot that shows thank you notes.

FIG. 13B is a screenshot that shows thank you notes as received by volunteers.

The figures depict embodiments of the present invention for purposes of illustration only. One skilled in the art will readily recognize from the following discussion that alternative embodiments of the structures and methods illustrated herein may be employed without departing from the principles of the invention described herein.

### DETAILED DESCRIPTION OF THE PREFERRED EMBODIMENTS

The figures and the following description relate to preferred embodiments by way of illustration only. It should be noted that from the following discussion, alternative embodiments of the structures and methods disclosed herein will be readily recognized as viable alternatives that may be employed without departing from the principles of what is claimed.

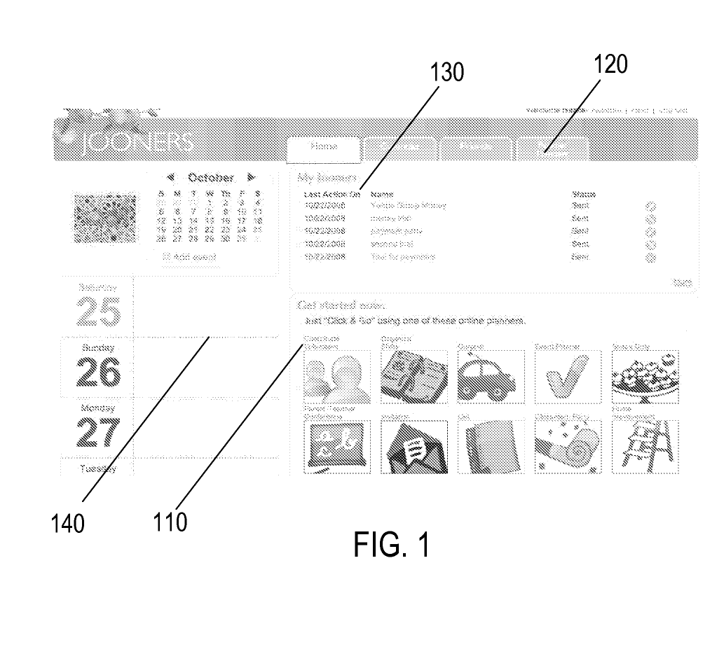

FIGS. 1-13 illustrate an example according to the invention. FIG. 1 is a screen shot of the home page of an example located at web site www.jooners.com. From this home page, the organizer can create new sign-up sheets, including accessing a gallery of pre-existing sign-up sheets (Popular Planners tab 120). He can also see all the different sign-up sheets that have been created, saved or sent, by accessing the My Jooners box 130. The organizer's own activities, time or item commitments are placed on his calendar 140.

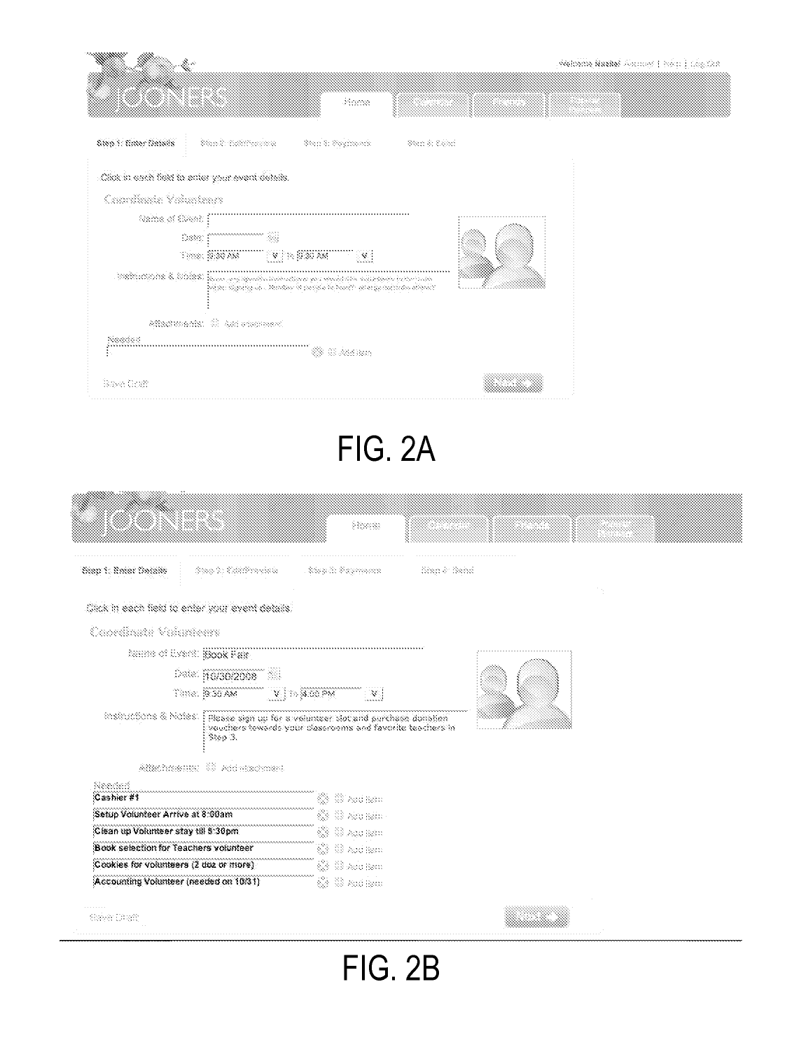

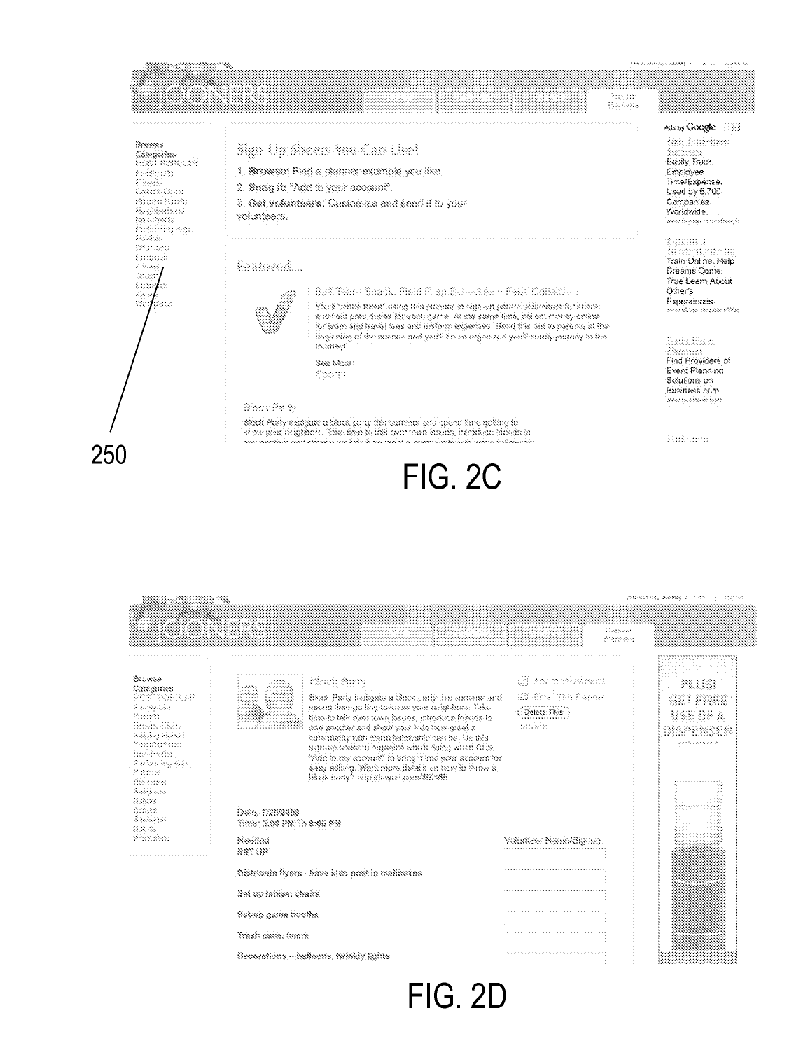

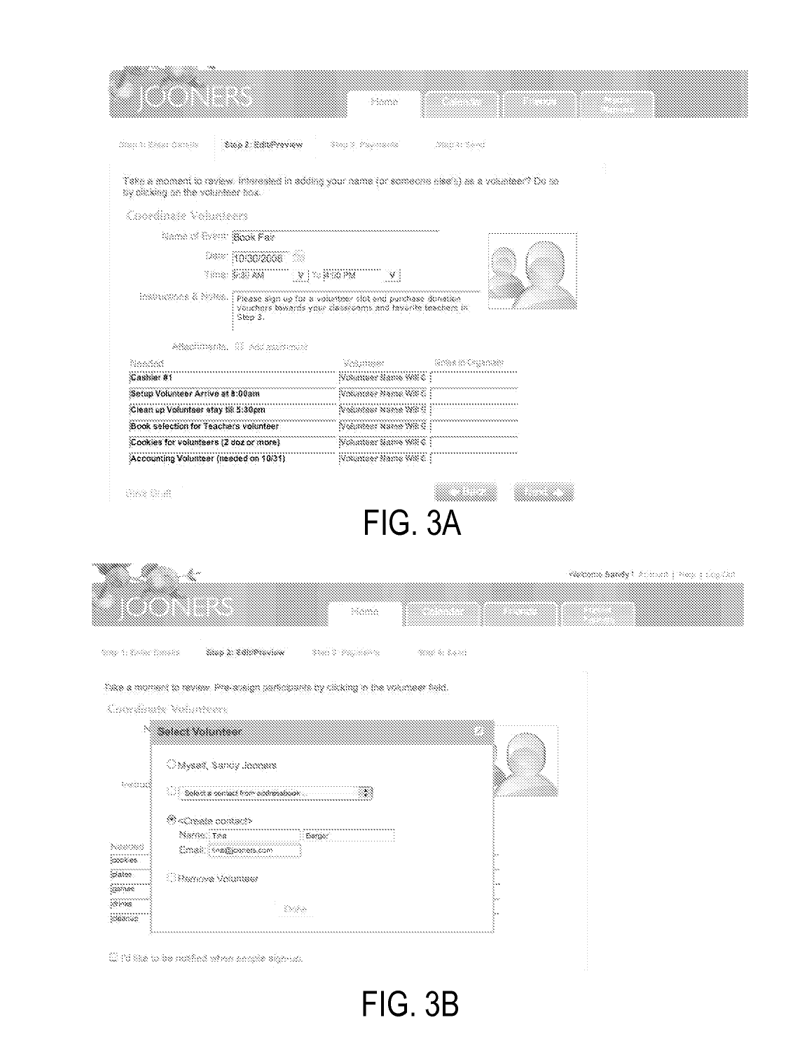

Clicking on Coordinate Volunteers 110 brings the organizer to a template for coordinating volunteers (i.e., a type of sign-up sheet). Step 1 of this template is shown in FIG. 2A. The organizer fills out this screen. An example of a filled out screen is shown in FIG. 2B. The organizer clicks the Next button to go to Step 2, as shown in FIG. 3.

Alternatively, the organizer can go to the Popular Planners tab 120, which contains a gallery of templates for sign-up sheets, depending on the nature of the activity. FIG. 2C is a screenshot that shows a gallery of sign-up sheets, organized by category 250. FIG. 2D is a screenshot that shows a sign-up sheet selected from the gallery, in this example it is a sign-up sheet for a block party. The organizer can then use the template to define his sign-up sheet.

The templates are used by the organizer to define his sign-up sheet. To facilitate this, the templates preferably are displayed in a manner that looks like a sign-up sheet. The organizer can then change the different aspects of the sign-up sheet. For example, the organizer can define different tasks for the activity. The tasks preferably can be defined using at least two different variable parameters. Examples include defining tasks by combinations of time, location, job function and required items.

In FIG. 3A, the organizer verifies the information entered previously and enters verbal commitments by pre-assigning tasks to specific volunteers. The organizer can save the sign-up sheet as a draft and return to it later. Pre-assignment of volunteers is included as part of the sign-up sheet creation process, in this example. The system is designed such that even these pre-assigned volunteers receive reminders and thank you notes and are dealt with as if they had signed up themselves. FIG. 3B shows a dialog box that shows the ability and control of the organizer to pre-assign and/or remove volunteers.

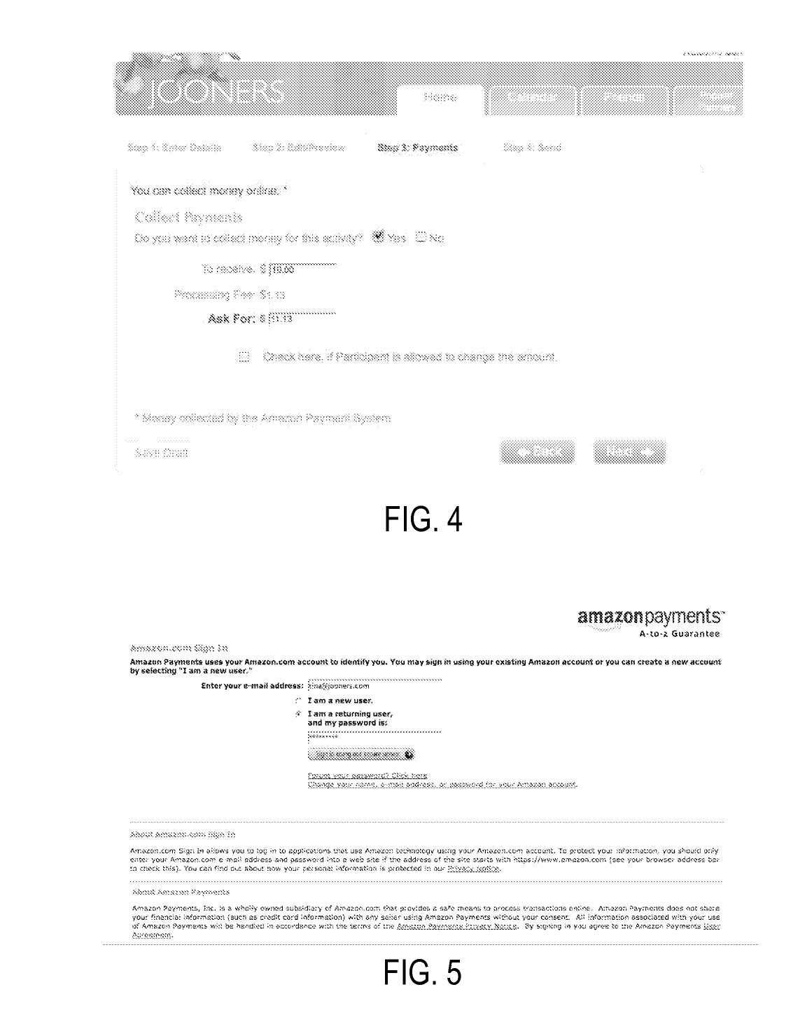

Clicking Next in FIG. 3A brings the organizer to Step 3, as shown in FIG. 4. Step 3, labeled PAYMENTS, gives organizers the ability to include payments with the sign-up sheet. In this example, the organizer can specify the suggested amount of the payment.

Once done specifying the payment parameters (amount, etc.), in this example, the organizer is taken to a separate payment platform provider such as Amazon where the setup and linking of the Payment services of Amazon is linked to this Jooners account/user. See FIG. 5.

Once done with the set up of the Payment services, the organizer is brought back to Jooners and the flow of setting up the template with payments is completed. Note that for accounting on who among the volunteers/participants has or has not paid, the user is taken to Amazon (in this implementation).

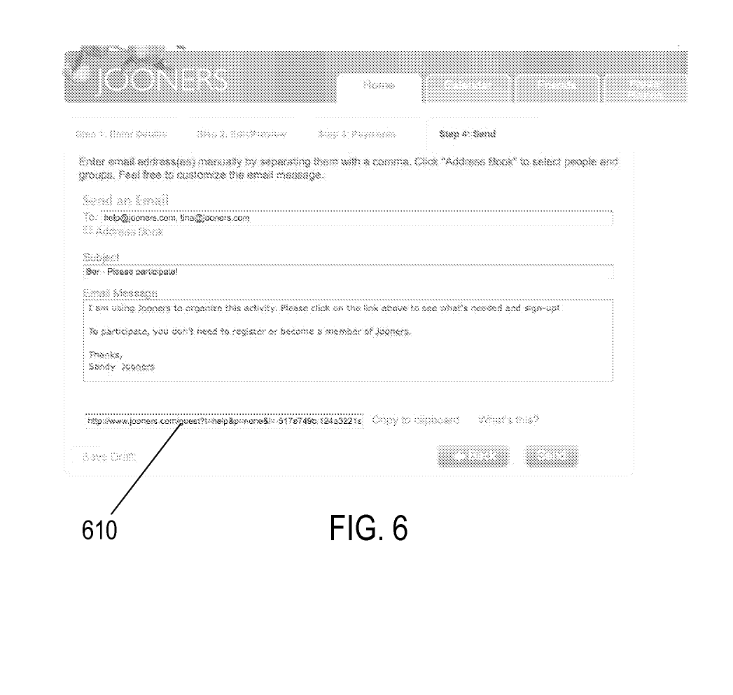

The last step in this example (Step 4), as shown in FIG. 6, facilitates the sending of the sign-up sheet (with payments capability) to volunteer candidates. In this example, the software platform auto generates an email, which the organizer can send to volunteer candidates. More importantly, the software platform creates a URL 610 for the sign-up sheet. The URL is presented to the organizer in a form that can be electronically copied into other communications. Thus, the organizer can send invitations using many other communications forms, and not only the forms generated by the software platform. The organizer can also send out invitations at different times. For example, the organizer might send out a first wave of invitations, wait to see how sign-ups progress, and then send out a second wave of invitations. The volunteers can also pass around the sign-up sheet simply by passing around the URL. In this example, the Jooners system auto generates an email invite, but the organizer can decide to use the URL generated by Jooners in a personal email to volunteer candidates (sent by the organizer not Jooners system), or various other social media vehicles such as blogs, newsletters, twitter messages etc.

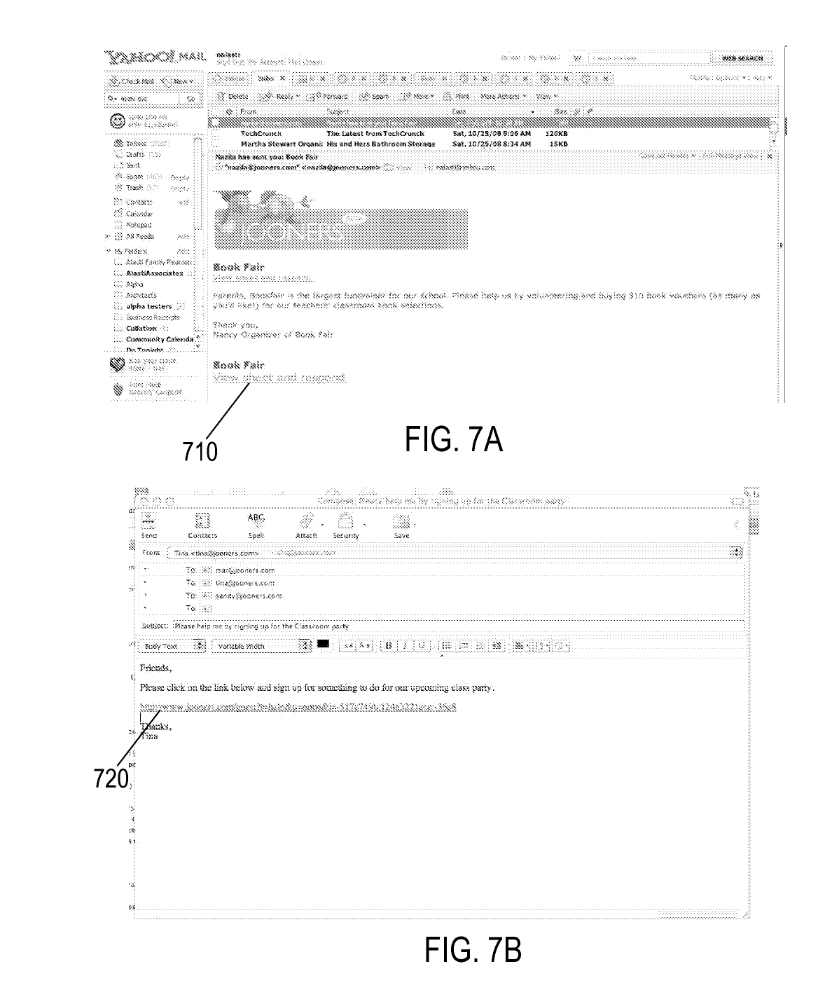

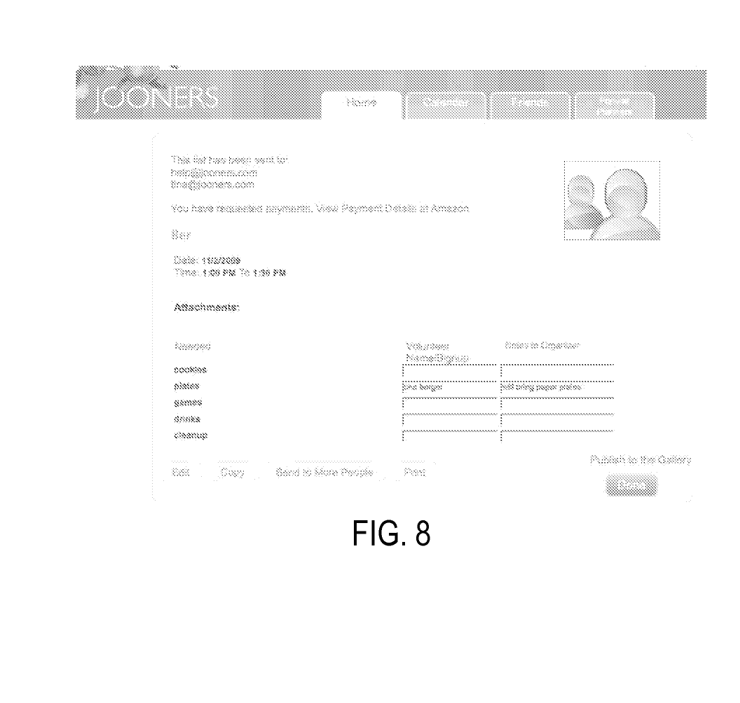

On the participant side, in FIG. 7A, the email auto-generated by the Jooners system is received by the participant in his/her normal email box. The organizer has customized the email message received by the participants. The participant clicks on a link 710 in the body of the email message and is directed to the sign-up sheet shown in FIG. 8, where the participant is able to sign-up for items in the list provided by the organizer, without needing to register for Jooners or have an account on Jooners (in this example).

FIG. 7B shows an example where the organizer independently sends out an email containing the URL 720 in the body of the email. The recipient can click on the URL to be directed to the sign-up sheet, as shown in FIG. 8.

From FIG. 8, the volunteer can see the entire sign-up sheet, including who else has already committed to which other tasks. This allows the volunteer to determine which tasks are still available. The sign-up sheet is automatically updated according to the volunteer's responses.

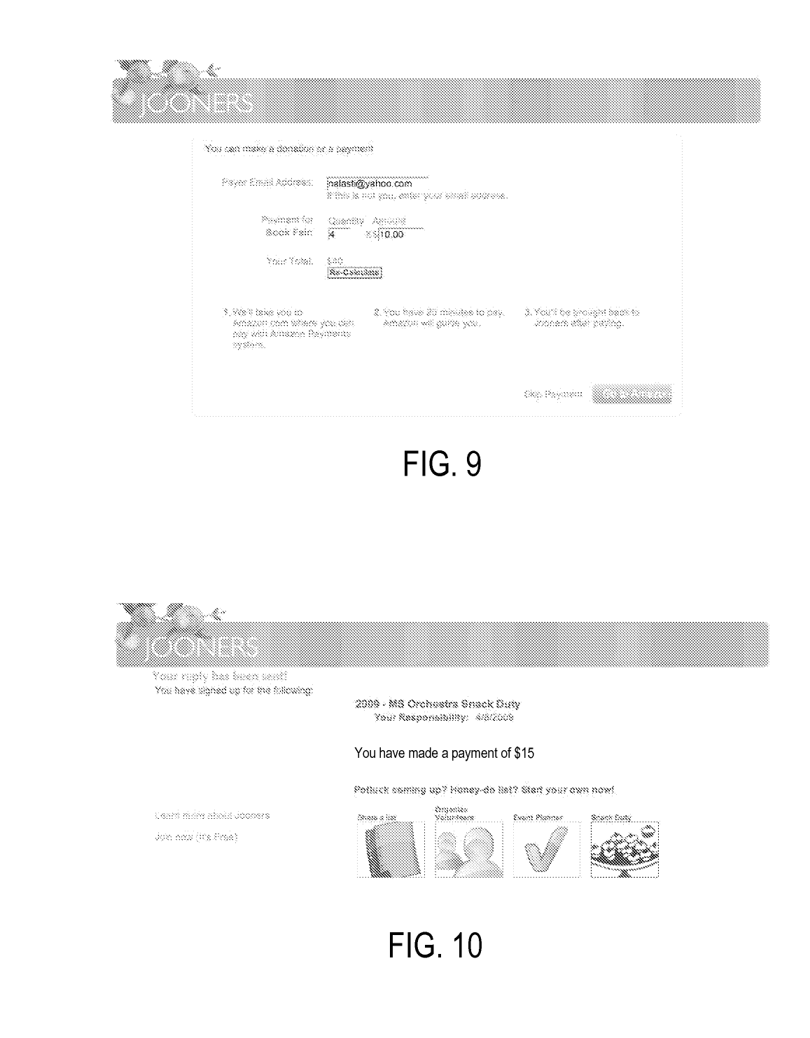

Clicking on NEXT in FIG. 8 navigates to the payments page, as shown in FIG. 9. In this example, the participant chooses the quantity of the payment and gets an estimated total. By clicking on PAY, the participant is taken to the payment platform such as Amazon to verify his/her credentials and make the payment. If payment is made, the participant is brought back to Jooners, for example the screen shot shown in FIG. 10. The payments page can be set up for many types of payments, for example paying for dues, tickets, or gift contributions.

The organizer can click on the item in his/her MY JOONERS box to see the confirmation that payment has been made and a list of tasks for which volunteers have committed. For the organizer, the accounting on who has paid can be shown on a screen. Also, the organizer can see what items have been committed to and go to the Amazon/Payment platform provider to see the list of payors. For volunteers and participants, they can click on the sign-up sheet URL to see who has committed to which tasks.

In one approach, integrity of the sign-up sheet is maintained by controlling authority to make changes to the volunteer commitments. One rule is to allow only the organizer to make changes. Thus, if a volunteer commits to a task and then later changes his mind, the volunteer must have the organizer change the commitment on the sign-up sheet. A different rule would be to allow both the organizer and the volunteer to change a volunteer's commitment. Authority may also vary over time, for example with more changes allowed when there is still time before the activity, and fewer changes allowed as the activity draws near.

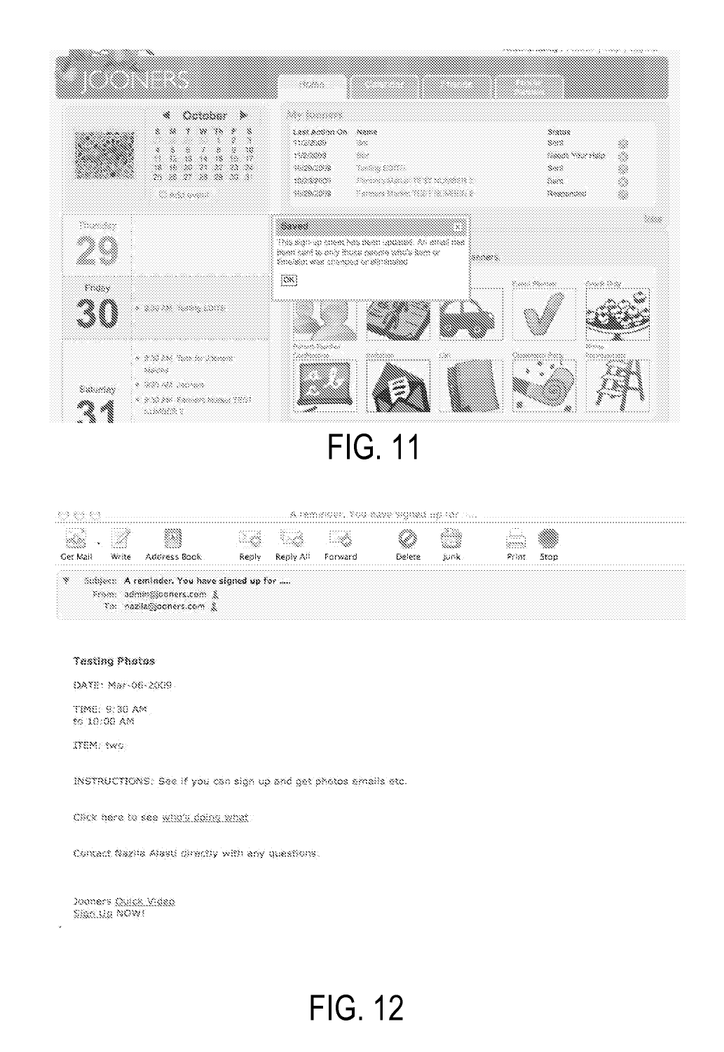

In the current example, the organizer can edit an existing sign-up sheet at either Step 1 or Step 2. If an organizer makes changes to an existing sign-up sheet, it would be useful to notify any affected volunteers, for example as shown in FIG. 11.

Other groups can also be useful. For example, the organizer may send his original email to a wide group of volunteer candidates. However, some later communications may go to only those volunteers who have signed up on the sign-up sheet, or to only those who have signed up for certain tasks.

For example, three days before the activity date, a reminder is automatically sent to all volunteers on the sign-up sheet, listing the date, item and timing of their commitment. FIG. 12 is an example of this. If changes were made throughout the process, they are reflected in these reminders. The ability to modify how soon or how many times a reminder goes out is defined by the organizer in this example. The ability to turn off reminders is in the hands of the volunteers, in this example.

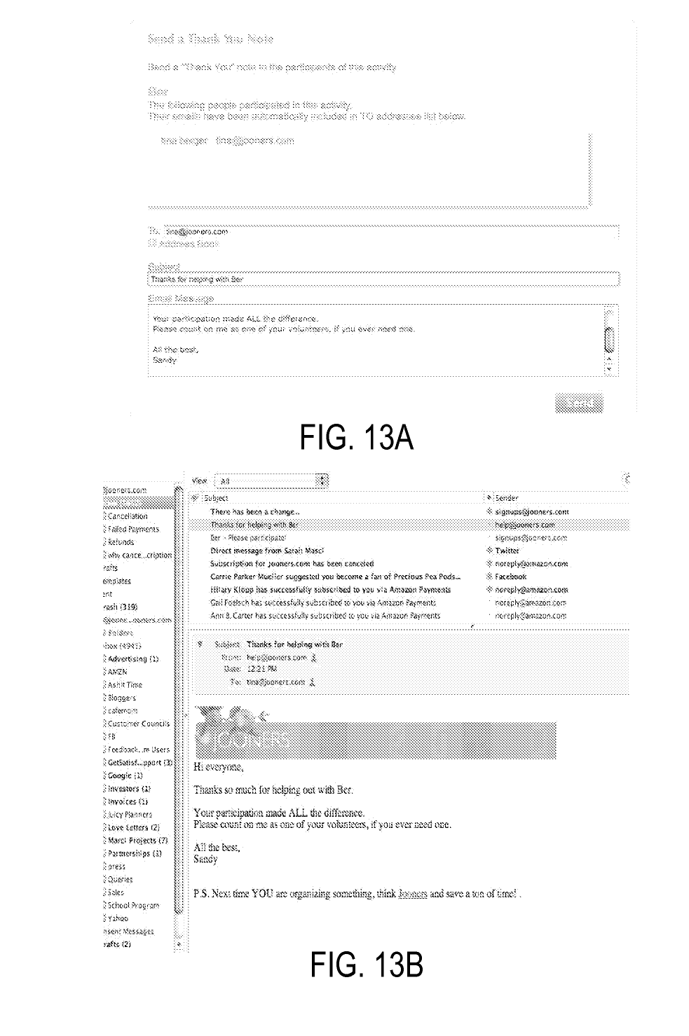

The organizer, at the conclusion of the activity, may decide to thank volunteers via an email. Jooners provides the ability to quickly create customized thank you notes that are sent to participating volunteers. For example, see FIGS. 13A and 13B.

The sign-up sheet examples shown above are especially useful for mid-sized, non-persistent groups. For very small groups, coordination can be done by emails or phone calls. For very large groups, more sophisticated software will have additional benefits. However, tools such as Jooners is especially useful for mid-sized groups, for example between 10 and 100 volunteer candidates, or even up to between 10 and 1000 volunteer candidates. It is also well-suited to transient groups—groups which come together for a temporary period of time. For example, permanently established groups that take on repetitive activities can develop other types of sign-up sheets due to their repeated nature.

Although the detailed description contains many specifics, these should not be construed as limiting the scope of the invention but merely as illustrating different examples and aspects of the invention. It should be appreciated that the scope of the invention includes other embodiments not discussed in detail above. Various other modifications, changes and variations which will be apparent to those skilled in the art may be made in the arrangement, operation and details of the method and apparatus of the present invention disclosed herein without departing from the spirit and scope of the invention as defined in the appended claims. Therefore, the scope of the invention should be determined by the appended claims and their legal equivalents.

What is claimed is:

1. An Internet-based method for helping an organizer of an activity to coordinate and track volunteers' commitments to tasks for the activity and for providing transparency to volunteers regarding which tasks are committed, the method comprising a computer system performing the steps of:
serving a first web document to the organizer, the first web document presenting a template used by the organizer to define a sign-up sheet of tasks for an activity, wherein the template allows the tasks to be defined using at least two different variable parameters and allows the organizer to pre-assign volunteers for tasks;
creating the sign-up sheet based on the organizer's response to the template, including committing pre-assigned volunteers to their respective tasks;
creating a URL for the sign-up sheet;
serving a second web document to the organizer, the second web document presenting the URL to the organizer in a form that can be electronically copied by the organizer into other communications;
receiving requests for the URL from volunteer candidates;
in response to the received requests for the URL, serving a third web document to the volunteer candidates, the third web document displaying the sign-up sheet, said display including which volunteers have committed to which tasks and allowing the volunteer candidates to commit to available tasks;
updating the sign-up sheet according to the volunteer candidate's responses to the third web document;
protecting the integrity of the volunteer commitments shown in the sign-up sheet by controlling authority to making changes to the volunteer commitments; and
allowing the organizer to change the sign-up sheet and, in response to changes made by the organizer, automatically electronically notifying volunteers who are affected by the changes.

2. The method of claim 1 wherein the first web document presents to the organizer the template used to define the sign-up sheet in substantially the same form as the third web document displays the sign-up sheet to the volunteer candidate.

3. The method of claim 1 wherein the template allows the tasks to be defined using at least two different variable parameters, the variable parameters including a time and a location of the task.

4. The method of claim 1 wherein the template allows the tasks to be defined using at least two different variable parameters, the variable parameters including a job function and a location of the task.

5. The method of claim 1 wherein the template allows the tasks to be defined using at least two different variable parameters, the variable parameters including a job function and a time of the task.

6. The method of claim 1 wherein the template allows the tasks to be defined using at least two different variable parameters, the variable parameters including at least two parameters selected from the group of time of task, location of task, job function and required items.

7. The method of claim 1 wherein volunteers may commit to tasks without being a registered user.

8. The method of claim 1 wherein there are not more than 1,000 and not less than 10 volunteer candidates.

9. The method of claim 1 wherein there are not more than 100 and not less than 10 volunteer candidates.

10. The method of claim 1 wherein the volunteer candidates are members of a transient group.

11. The method of claim 1 wherein serving the first web document to the organizer comprises presenting to the organizer a step-by-step process to define the sign-up sheet.

12. The method of claim 11 wherein serving the step-by-step process includes not more than five expressly identified steps.

13. The method of claim 1 wherein the activity is a one-time event.

14. The method of claim 1 wherein the activity is a recurring event.

15. The method of claim 1 wherein the activity has shifts.

16. The method of claim 1 further comprising:
allowing the organizer to send notices to only those volunteers who have committed to tasks on the sign-up sheet.

17. The method of claim 1 further comprising:
allowing the organizer to define automatically-sent reminders of the activity to be sent to only those volunteers who have committed to tasks on the sign-up sheet, the reminders automatically sent on dates set by the organizer.

18. The method of claim 1 wherein only the organizer has authority to make changes to the volunteers' commitments to tasks.

19. The method of claim 1 wherein the first web document is selected from a gallery of templates, depending on a nature of the activity.

20. The method of claim 1 wherein the third web document displays all tasks in the sign-up sheet and all volunteers who have committed to tasks in the sign-up sheet.

21. The method of claim 1 wherein:
the sign-up sheet includes a possible payment; and
the third web document allows the volunteers to make payment.
